(19) United States
(12) Patent Application Publication
(10) Pub. No.: US 2011/0117153 A1
(43) Pub. Date: May 19, 2011

(54) SPINOSYN BAIT FORMULATIONS FOR THE CONTROL OF COCKROACHES AND METHODS OF USING THE SAME

(76) Inventor: Christine Kritikou, Krfissia (GR)

(21) Appl. No.: 12/934,326

(22) PCT Filed: Mar. 25, 2009
(86) PCT No.: PCT/IB2009/005848

§ 371 Date: Nov. 30, 2010

Related U.S. Application Data
(60) Provisional application No. 61/039,875, filed on Mar. 27, 2008.

(51) Int. Cl. A01N 25/00; A01N 43/22; A01N 59/00; A01P 7/04

(52) U.S. Cl. 424/405; 514/28; 424/84; 424/600

(57) ABSTRACT

The present invention relates to a pest control product in an ingestible form, comprising at least one active ingredient in need of masking, e.g., spinosyn or derivative or salt thereof, and at least one masking agent, wherein said product achieves mortality against cockroaches. The present invention also relates to a pest control product in an ingestible form, wherein at least one spinosyn is microencapsulated, and wherein said product achieves mortality against cockroaches. The present invention also relates to a method for controlling cockroach populations by administering the pest control product.

Most species of cockroaches feed off vegetable debris on forest floors; however, many are significant pests, having adapted to the human environment. The losses caused by cockroaches include spoilage of food and transmission of pathogenic microorganisms, such as those that cause diarrheal diseases, as many domestic cockroaches live in or obtain water from drains and sewers. Cockroach infestations have also been linked to increased incidences of asthma caused by cockroach allergens. Additionally, cockroaches emit an unpleasant smell and may damage household items, such as fabrics.

While measures may be taken to prevent and limit the establishment of cockroach populations, once infestation is established, insecticides must be used to reduce or eliminate the population. Various insecticides have proven effective against cockroaches, as identified in “Pesticides and Their Application, For the Control of Vectors and Pests of Public Health Importance,” World Health Organization, 6^{th} ed., 70-73 (2006), which is incorporated herein by reference. However, insecticide resistance is a significant problem, particularly with cockroaches, rendering many compounds ineffective. Resistance to organochlorine, organophosphate, carbamate, and pyrethroid insecticides has been reported in the German cockroach, which is the most prevalent pest species. In general, these chemicals are gradually being replaced by more modern insecticides. When feasible, alternating between insecticide classes is recommended to delay the build up of resistance. Moreover, because insecticides are often used in domestic environments, particularly kitchens, there is an interest in the possible harmful effects of wide scale and prolonged use of synthetic insecticides on human health, as well as the environment.

The control of cockroaches, which bother and/or harm people, animals, and crops, has been the subject of extensive research, and there are many well-known methods and products for killing or reducing the population of cockroaches. Nonetheless, new, safe, and effective methods, compositions, and delivery systems are needed to control cockroach populations.

One series of active ingredients that have been used in the control of other pests are spinosyns. Spinosyns are known fermentation products derived from the naturally occurring bacteria Saccharopolyspora spinosa. The family of compounds derived from this bacteria are generally known as spinosyns and have been referred to as factors or components A, B, C, D, E, F, G, H, I, J, K, L, M, N, O, P, Q, R, S, T, U, V, W, Y, and the like, as described in U.S. Pat. Nos. 5,362,634, and 6,821,526 and published applications WO 93/09126 and WO 94/20518, which are each incorporated herein by reference in their entirety.

The spinosyn compounds include a 5,6,5-tricylic ring system, fused to a 12-membered macrocyclic lactone, a neutral sugar (rhamnose), and an amino sugar (forosamine) (See Kirst et al. (1991)). As used herein, the term “spinosyn” refers to a class of compounds which are based upon the fermentation products from the naturally occurring bacteria, Saccharopolyspora spinosa (species and subspecies) or a biologically modified form of this bacteria. Natural spinosyn compounds may be produced via fermentation from cultures deposited as NRRL 18719, 18537, 18538, 18539, 18743, 18395, and 18823 of the stock culture collection of the Midwest Area Northern Regional Research Center, Agricultural Research Service, United States Department of Agriculture, 1815 North University Street, Peoria, Ill. 61604. Spinosyn compounds are also disclosed in U.S. Pat. Nos. 5,496,931, 5,670,364, 5,591,606, 5,571,901, 5,202,242, 5,767,253, 5,840,861, 5,670,486 and 5,631,155.

As used herein, the term “spinosyn” is intended to include natural factors and semi-synthetic derivatives of the naturally produced factors, or a salt thereof, and all isomers of the compounds. A large number of chemical modifications to these spinosyn compounds have been made, sometimes referred to as spinosoids and are disclosed, for example, in U.S. Pat. No. 6,001,981, hereby incorporated by reference. Spinosyn also includes the novel biologically-active compounds as described in U.S. Patent Publication No. 2006/0040877 produced by methods of using the hybrid polyketide synthase DNA to change the products made by spinosyn producing strains. Finally, the term “spinosyn” includes new spinosyn derivatives that may have a different spectrum of insecticidal activity produced using the cloned Saccharopolyspora spinosa DNA as described in U.S. Pat. No. 7,015,001. Different patterns of control may be provided by biosynthetic intermediates of the spinosyns or by their derivatives produced in vivo, or by derivatives resulting from their chemical modification in vitro. Such biosynthetic intermediates of the spinosyns are considered to belong to the class of “spinosyns” as described herein for use in the present invention.

Spinosad is an insecticide produced by Dow AgroSciences (Indianapolis, Ind.) that is comprised mainly of approximately 85% spinosyn A and approximately 15% spinosyn D. Spinosad is an active ingredient in several insecticide formulations available commercially from Dow AgroSciences LLC, including, for example, those marketed under the trade names TRACER®, SUCCESS®, SPINTOR®, LASER®, and ENTRUST®. The TRACER® product, for example, is comprised of about 44% to about 48% Spinosad (w/v), while ENTRUST® is a white to off-white solid powder containing about 80% Spinosad.

Spinetoram is a semi-synthetic spinosyn, available commercially from Dow AgroSciences LLC in several insecticide formulations, including, for example, those marketed under the trade names DELEGATE® and RADIANT®. Spinetoram is the common name for a mixture of 50-90% (2R,3αR,5αR,5βS,9S,13S,14R,16αS,16βR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,4,5,5α5β, 6,9,10,11,12,13,14,16α,6β-hexadecahydro-14-methyl-1H-as-indaceno[3,2-d]oxacyclodo decine-7,15-dione, and 50-10% (2R,3αR,5αS,5βS,9S,13S,14R,16αS,16βS)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,5α,5β,6,9,10,11,12,13,14,16α,16β-tetradecahydro-4,14-dimethyl-1H-as-indaceno[3,2-d]oxacyclododecine-7,15-dione. Synthesis of the components of spinetoram is described in U.S. Patent Publication No. 2007/0104750 and U.S. Pat. No. 6,001,981.

Macrolide insecticides related to the spinosyns are contemplated within the scope of the defined term “spinosyns” and have been isolated from Saccharopolyspora sp. LW107129 (NRRL 30141 and mutants thereof). These compounds are disclosed in U.S. Pat. No. 6,800,614, hereby incorporated by reference. These compounds are characterized by the presence of reactive functional groups that make further modifications possible at locations where such modifications were not feasible in previously disclosed spinosyns. Natural and semi-synthetic derivatives of the butenyl spinosyns are disclosed in U.S. Pat. No. 6,919,464, hereby incorporated by reference. The term “butenyl-spinosyn”—also called pogonin—as used herein is intended to include natural factors and semi-synthetic derivatives of the naturally produced factors and it is considered to belong to the same class of “spinosyns” as described herein for use in the present invention.

Spinosad has been shown to be highly effective in the control of certain pests and insects including, but not limited to species from the orders Lepidoptera, Diptera, Hymenoptera, Thysanoptera, and a few Coleoptera. In addition, formulations comprising Spinosad have been shown to be highly effective in a variety of different environments including agricultural, horticultural, greenhouses, golf courses, gardens, homes, and the like.

Spinosad acts as a stomach and contact poison. Generally, the immediate effect of ingestion is the cessation of feeding, followed 24 hours later by paralysis and death. This compound is a neurotoxin with a novel mode of action involving the nicotinic acetylcholine receptor and GABA receptors. Due to this specific mode of action, an immediate kill of pests, including cockroaches is not expected. Therefore, effective control of the target pests may not be immediately apparent and, instead, may be observed over a period of time.

As used herein, the terms “effective,” “effective in the control of,” and “effective for control” or “control” are all used interchangeably and all refer to the ability of the composition/active to achieve a kill rate or mortality of at least 60% in 21 days or less, with regard to a mixed population, i.e., one including females, males, and nymphs (larvae). When a specific gender, i.e., females, males, and/or nymphs, is being singled out, it is specifically noted herein.

Spinosyns, including Spinosad, have been found to have very favorable environmental and toxicological profiles, thus making them particularly advantageous in the control of pests and insects. In addition, Spinosad has been found to be highly effective in the control of detrimental pests and insects while maintaining minimum disruption to beneficial insects and other non-target organisms. Moreover, Spinosad has been shown to be relatively low in toxicity to mammals and birds and is only slightly toxic to fish. Chronic toxicology tests in mammals have shown that Spinosad is not carcinogenic, teratogenic, mutagenic, or neurotoxic. There is no cross-resistance to synthetic and traditional biological insecticides. Moreover, Spinosad is classified by the U.S. Environmental Protection Agency as an environmentally and toxicologically reduced risk material. Spinosad and Spinetoram have both won the US Presidential Green Chemistry Award.

While spinosyns have heretofore been known to be effective when ingested by pests, thereby causing rapid excitation of the nervous system, these applications have not been effective against cockroaches and spinosad is not included within the WHO list of insecticides suitable for cockroach control. For example, spinosyn containing bait stations of the prior art were effective against houseflies, as described in U.S. Pat. Nos. 6,821,526 B1 and 6,585,990 B1, and used in formulations topically applied to animals to treat for infestations, as described in U.S. Pat. No. 6,933,318 B1, all of which are incorporated herein by reference. Spinosyns, however, have not been shown to be effective in the control of cockroaches. For example, Wei et al., Pyrethroid resistance and cross-resistance in the German cockroach, Blatella germanica (L), Pest Manag. Sci., 57:1055-1059 (2001), which is incorporated herein by reference, reports that Spinosad was relatively slow acting and had relatively low toxicity against German cockroaches, compared with other insecticides studied. Likewise, in U.S. Pat. No. 6,001,981, which is incorporated herein by reference, Spinosad was shown to be effective against insects and mites but minimally effective against cockroaches, only 20-40% efficacy.

### SUMMARY OF THE INVENTION

The present invention relates to ingestible formulations and products containing at least one spinosyn or derivative or salt thereof that are effective in the control of cockroaches and methods of using the formulations.

According to one embodiment, the present invention relates to a pest control product in an ingestible form, comprising at least one spinosyn or derivative or salt thereof and at least one masking agent. The product achieves at least 60% mortality in 21 days or less against cockroaches. One of skill in the art would appreciate that the present invention is effective against cockroaches, while exhibiting the favorable environmental and toxicological attributes of spinosyns. Further, the products of the present invention may be effective against cockroaches otherwise resistant to common insecticides.

It has been found that at least one spinosyn in combination with a masking agent is an effective cockroach control. As used herein “cockroach” refers to insects of the order Blattodea, including, but not limited to the American cockroach (Periplaneta americana), the German cockroach (Blattella germanica), the Asian cockroach (Blattella asahinai), and the Oriental cockroach, (Blatta orientalis). As used herein, the term “cockroach” refers to a mixed population, i.e., it includes females, males, and nymphs (larvae), unless it is specifically noted otherwise by reference to a particular gender. It has been found that the effectiveness of spinosyn may vary depending upon the type of cockroach, both species and gender. For example, American cockroaches tend to be larger than German cockroaches and, therefore, may require more active to be killed. Even in the same species of cockroaches, different strains vary in their sensitivity to a toxicant. It is also well known that males are much more sensitive and, therefore, much easier to eliminate than females and nymphs, which are very tolerant. Control of nymphs is also essential for complete eradication of a cockroach population.

As used herein, the terms “masking agent”, “masking” and “mask” refer to anything, such as a substance (component) or method, or any combination of different substances, or combination of methods or combination of substances and methods or a specifically high concentration of a substance or substances, that interferes with the perception of the presence of spinosyn, such that a cockroach is not repelled by and/or does not stop feeding on a pest control product containing spinosyn. Included within the term “masking agent” are inhibitors of the bitter or other taste response as described, for example in U.S. Reissue patent RE 40,594, as well as odor neutralizers i.e. ingredients that are capable of reducing the intensity of malodors without themselves possessing any significantly intense odor or fragrance. Such odor neutralizers, described for example in European Patent No. 1239890, incorporated herein by reference, do not exactly mask malodors but instead neutralize them, thus providing the possibility of reducing the quantity of the substance previously required for masking odors. In addition, under the term “masking agent” is included the para-hydroxyphenylacetic acid which is used for reducing the repellency of insecticides, as mentioned in U.S. Pat. No. 5,741,501 incorporated herein by reference.

As used herein, the term bait refers to a product or formulation which incorporates an insecticide in an attractive and palatable food. According to one embodiment, the bait, is not only palatable and non-repellent, but it is easy to consume and toxic in the amounts consumed. According to one embodiment, the food includes refined animal fat.

Even though cockroaches do not smell and taste as humans do, cockroaches are equipped with highly developed sensory organs in the antennae, palps, and mouthparts that assist them with selecting a suitable food source. Without wishing to be bound by theory, this sensory property is referred to herein as “smell” and/or “taste” and variations thereof. It has been found that most cockroaches, especially females and nymphs, are repelled by spinosyn, most likely due to its characteristic scent or taste or by an unspecified factor, resulting in either no consumption of the bait product or a cessation of feeding after first trial taste. Because of this repellency, spinosyn is not effective in the control of cockroaches. Conventional formulations that are attractive and effective to cockroaches are found to be unattractive and non effective when the active is replaced with spinosyn. In a test carried out with the same conventional food matrix, one bait including chlorpyrifos and the other including Spinosad, it was found that 92% of the very hungry German cockroaches were attracted to the bait containing chlorpyrifos (determination of attractiveness was made by an infrared operating image analysis system). In fact, it has also been found that cockroaches may reject conventional formulations if they contain spinosyn even in the absence of alternative foods, i.e., cockroaches may go without food rather than consume spinosyn containing bait formulations. It has been found that the products of the present invention, which are comprised of spinosyn and a masking agent, are attractive to cockroaches and achieve at least 60% mortality in 21 days or less.

Examples of masking agents used in the present invention, generally used in combination with a basic food (containing, for example, refined animal fat), include, but are not limited to unrefined animal fats, such as liquid unrefined pork fat. The unrefined animal fat may be present in an amount greater than 5%, for example from 5 to 50%. Masking agents for use in the present invention can include lecithin, for example, at percentages of 5% or greater, including for examples, 11% or greater, 20% or greater, 30% and greater and 40% and greater, specifically for example 40.5%; Masking agents can further include plant or vegetable oil, for example, at percentages of 5% or greater, including for example 11% or greater, 15% or greater, 20% or greater and 25% or greater, specifically by way of example 27%. Finally the masking agent according to the present invention can include microencapsulation. Masking agents according to the present invention can include combinations of the above.

Plant or vegetable oils may be selected from the group consisting of soy bean oil, rapeseed oil, sesame oil, wheat germ oil, cotton oil, corn oil, olive oil, sunflower oil and other art recognized plant and vegetable oils. Lecithin, may be produced from any source including but not limited to egg yolk, soy bean oil, and sunflower oil. According to one embodiment lecithin used in the present invention is of soy bean oil origin.

Using this novel spinosyn containing product, one may achieve reduced insecticide use rates and improved efficacy. According to one embodiment, for example, products containing only from 0.5% to 2% Spinosad and unrefined animal fat may achieve greater than 90% mortality against German cockroaches within 14 days, measured in the mixed population, and males are completely eliminated within 7 days.

It has also been found that methods may be employed for disrupting the perception of the offensive smell and/or taste of spinosyn by the target population, for example by microencapsulation of the spinosyn. Spinosyn can be microencapsulated using the method disclosed in U.S. Pat. No. 6,932,984. Generally, the microencapsulated spinosyn of the present invention is not substantially released from the encapsulation until it is in the mouth or digestive system of the cockroach. In a laboratory scale test carried out with the same conventional food matrix, having non encapsulated Spinosad in one bait and microencapsulated Spinosad in another (at the same rate of pure active), it was found that most of the very hungry German cockroaches (59%) were attracted to the bait containing the microencapsulated Spinosad. This test was performed on microencapsulated Spinosad produced at laboratory scale and containing significant amounts of free spinosyn. The percentage of cockroaches attracted to the matrix is expected to increase significantly upon full scale, optimized production of the microencapsulated active, as the repellant effect of free spinosyn between the capsules will be reduced. Thus, the present invention also relates to microencapsulated spinosyn formulations effective in the control of cockroaches.

The present invention also relates to methods of using spinosyn formulations to achieve at least 60% mortality in 21 days or less against cockroaches. The formulations used in the methods include those containing spinosyn with a masking agent component and those containing spinosyn masked by microencapsulation, as set forth herein.

The present invention further relates to the discovery that spinosyns may be useful pesticides as against pest classes, like cockroaches, heretofore believed to be tolerant or resistant to spinosyn and against which spinosyn was not up to now recommended due to poor efficacy. Thus, in one embodiment, the present invention relates to a method for formulating a spinosyn containing bait comprising identifying an effective amount of spinosyn that balances the efficacy of the spinosyn against its repellant properties. Further, according to another embodiment of the present invention an appropriate mask is included. Specifically, regarding cockroach bait formulations, the amount of spinosyn is selected to achieve the necessary mortality rate in the selected insect population without adding an amount of spinosyn in excess of the effective amount such that this excess amount would negatively impact the properties of the bait by rendering it repellant. The products and methods of the present invention and their application can be used in, but are not limited to, general household or professional insecticide applications or in public health applications.

### DETAILED DESCRIPTION OF THE INVENTION

Not wishing to be bound by theory, the present inventor discovered that spinosyn containing compositions were often ineffective against cockroaches, not because of lack of spinosyn effectiveness, but because the presence of the spinosyn repelled cockroaches. The inventive compositions contain a masking agent, effective in concealing the presence of spinosyn, such that the cockroaches consume the bait formulation in effective quantities. According to one embodiment, the formulations comprising at least one spinosyn, are combined with a masking agent, such that the product achieves at least 60% cockroach mortality in 21 days or less, such as in 16 days, 14 days, or even 7 days. In other embodiments, the formulations achieve at least 70%, 80%, or even 90% mortality in 21 days or less. Masking agents effective in the products include unrefined animal fats, such as liquid unrefined pork fat, lecithin at levels of 5% or greater, for example, 11% or greater, 20% or greater, specifically for example 40.5%, and soy bean oil at levels of 15% or greater, for example 27% which in combinations with the refined animal fat may synergistically act as masking agent. The present invention also relates to microencapsulated spinosyn, as microencapsulation is an alternative masking agent.

The primary active ingredient for use in the present invention comprises at least one spinosyn from the class of spinosyns as described above. The active ingredient should be present in an amount sufficient to be active against cockroaches. The upper limit of activity may be driven by characteristics of cost, the cockroach species targeted, and toxicity that would be readily apparent to the skilled artisan. One skilled in the art would recognize that the amount of spinosyn could be reduced in the event a second active were present, so long as the combined composition is active as against cockroaches.

According to one embodiment, the spinosyn is present in the composition in an amount in the range from 0.005% to 20%. According to another embodiment, the spinosyn is present in an amount in the range from 0.01% to 20%. According to another embodiment, the spinosyn is present in an amount in the range from 0.1% to 10%. According to yet another embodiment, the spinosyn is present in an amount in the range from 0.5% to 5%.

As noted herein, spinosyn does not produce an immediate kill of the target pest, in this case cockroaches. Therefore, the mortality rates given herein are achieved over time. In one embodiment of the present invention, the desired mortality rate is achieved in 21 days or less, such as in 16 days, 14 days, or even 7 days.

Mortality rates achieved by the present invention range from 50-100% relative to the duration of exposure, the cockroach gender and strain, the period of the year the test is carried out relative to their reproduction cycle and activity and concentration of spinosyn in the formulation. One of skill in the art would be capable of optimizing these variables to achieve the desired mortality. For example, in one embodiment, when German cockroaches were exposed to a product containing 2% by weight of spinosyn for 14 days, the product achieved 90%, 100%, and 97% mortality against female, male, and nymph cockroaches respectively, for an average mortality of 96%. When the period of exposure was increased to 16 days, the product achieved 97%, 100%, and 97% mortality against female, male, and nymph cockroaches respectively, for an average mortality of 98%. Notably, 100% killing of the males was achieved within the first 7 days. In another 14 day study, a product containing 2% by weight of spinosyn achieved an average mortality of 63% against American cockroaches and an average mortality of 93% against German cockroaches. Thus, in one embodiment of the present invention, the formulations achieve at least 60% cockroach mortality, such as at least 70%, 80%, or even 90% mortality, in 21 days or less.

According to one embodiment, the spinosyn and masking agent are also combined with at least one food ingredient, at least one attractant, and/or at least one preservative and/or antioxidant, wherein the at least one food ingredient and/or at least one attractant are different from the masking agent.

Food ingredients for use in the present invention include any art recognized foods acceptable to cockroaches in bait formulations. A non-exhaustive list of food ingredients for use with spinosyns includes: hydrogenated fats, proteins, peanut oil, soybean oil; dried grains, such as oats, corn flour, and soy flour; and sugars, such as fructose, fructose corn syrup, honey, glucose, sucrose, cellulose, and powdered sugar. According to one embodiment of the invention, food ingredients may comprise from 5-99.5% by weight of the product, such as 50-95%, 70-95%, or even 80-95%. According to one embodiment, the food comprises 3 to 30% carbohydrates. According to another embodiment, the food ingredients comprise from 5 to 40% starches and oats. According to yet another embodiment, the food comprises from 3 to 40% hydrogenated fat.

By the term attractant as used in the present invention, it is meant any ingredient that makes the bait attractive and/or palatable to cockroaches (potentially acting as feed stimulant as well). To be most effective an attractant should be more attractive than other ingredients present near the bait (i.e., alternative food sources). The presence of a repellent ingredient within the bait may render the attractant less effective therefore its concentration may need to be adequately increased. Attractants for use in the present invention include any art recognized attractant acceptable to cockroaches in bait formulations. A non-exhaustive list of attractants includes: soy bean and peanut oil, curry powder, pheromones, flavor essences, and spices. According to one embodiment of the invention, curry powder is used as an attractant. According to another embodiment of the invention, soy bean oil is used as an attractant and in high concentrations, for example, 27% may act synergistically with refined animal fat as a spinosyn masking agent. According to one embodiment of the invention, attractants may comprise from 0.001-80% by weight of the product, such as 0.01-80%, 1-40%, 1-30%, or even 10-30%. According to one embodiment, the attractant is present in an amount from 0.1 to 5%.

Preservatives and antioxidants for use in the present invention include any art recognized preservative or antioxidant. A non-exhaustive list of preservatives and antioxidants includes potassium sorbate, sorbic acid, 1,2-benzisothiazolin-3-one (BIT) sold under the PROXEL trade name, and butyl-hydroxy-toluol (BHT). According to one embodiment of the invention, potassium sorbate is used as a preservative. Preservatives are present in an amount effective to maintain the stability of the product for a desired period of time. According to one embodiment of the invention, the preservative may comprise 0.0001 to 10% by weight of the product, such as 0.001 to 10%, 0.01-5%, 0.1%-2%, or even 0.1-1%. According to one embodiment, the preservative or antioxidant is present in an amount from 0.01 to 1%.

Other ingredients that may optionally be used in the present invention are binding agents such as starches, for example corn flour, which in addition to providing binding properties may effect the texture of the formulation and act as a food source.

Formulations for use with the present invention may also contain suitable secondary active ingredients. A secondary active ingredient is any compound which itself is active against cockroaches or another target pest or which aides or assist the primary active against cockroaches or another target pest. Non-limiting examples of such secondary active ingredients include pyrethroids (as an example cyphenothrin, sumithrin, cypermethrin), nicotinoids (as an example imidacloprid), fiproles (as an example fipronil), organophosphates (as an example malathion, chlorpyrifos), carbamates (as an example bendiocarb), insect growth regulators (as an example lufenuron), botanicals (as an example pyrethrum, d-limonene), inorganics (as an example boric acid), avermectins (as an example abamectine) and hydramethylnon. Appropriate combinations will be readily apparent to the skilled artisan. Such combinations could take advantage of different physical and biological properties of more than one active together in a single product. They could likewise be used, for example, in a product aimed at treating more than one pest with a single application or in a product aimed at achieving for example both knockdown/killing results at the same time.

Formulations for use in the present invention can also include other non-active ingredients commonly associated with pesticides and insecticides, including, but not limited to human taste deterrents, such as for example denatonium benzoate in an amount non detectable, and thus non repellent by cockroaches, perfumes, colorants, stabilizers, synergists (as an example piperonyl butoxide (PBO), n-octyl bicycloheptene dicarboximide (MGK), and Verbutin), emulsifiers, such as lecithin, surfactants, gel formers, humectants, and silicon compounds. Art recognized materials typically included in products of this nature will be readily apparent to one of ordinary skill in the art.

Formulations of the present invention may be administered in any art recognized ingestible forms. The formulations may be, but are not limited to, solid, liquid, gel, or foam. They may be administered as a bait using any art recognized application method, including but not limited to bait stations (as an example those made of plastic, paper, wire, or aluminum), tubes, syringes, granules, dusts, aerosols/sprays, and other modes of administration known in the art.

According to another embodiment of the present invention cockroach baits containing a masking agent may be used in combination with other active ingredients (not spinosyns), which although they are effective against cockroaches when administered in non-baiting systems, they can not be used in cockroach bait systems, because it is known from the prior art that they are highly repellent. Pyrethrins, (such as for example sumithrin and cyphenothrin), are an example of repellent materials. The present inventor created formulations with pyrethrins, for example cyphenothrin, very well known as repellent in cockroach bait formulations and tested those formulations against Blatella Germanica and Periplaneta Americana species. The products tested have shown at least 60% mortality in 21 days or less against cockroaches. In one 21 day study against Blatella germanica, a product containing 1% pure cyphenothrin as the active ingredient with a matrix having a masking agent, mortality rates reported were 62.2% in 14 days and 68.9% in 21 days. In another 14 day study against Periplaneta Americana, a product containing 2% pure cyphenothrin as the active ingredient with a matrix having a masking agent, mortality rates reported were 67.8% in 3 days and 87.8% in 14 days.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contain certain errors necessarily resulting from the standard deviation found in their respective testing measurements.

By way of non-limiting illustration, concrete examples of certain embodiments of the present disclosure are given below. It will be apparent to those skilled in the art that embodiments described herein may be modified or revised in various ways without departing from the spirit and scope of the invention.

### Example 1

Deionised water was heated to 70° C. and potassium sorbate and fructose were dissolved therein to form a viscous syrup of 20% water, 2% potassium sorbate, and 78% fructose. When the syrup temperature fell to approximately 45-50° C., a commercially available Spinosad product containing 44% pure Spinosad was added.

In a 150 ml glass bowl, hydrogenated animal fat, liquid unrefined pork fat, and soy bean oil were heated until they become liquid at 105° C. The mixture was stirred into corn flour at a rate of 500 RPM. During stirring, the mixture was allowed to cool to 93° C. and became less viscous. Stirring was continued for 5 more minutes. Lecithin was slowly added, and the temperature was adjusted to 85° C. The mixture became dark brown in color, and stirring was continued for an additional 10 minutes. The remaining fructose was added while stirring. Powdered Quaker oats and curry were added, and the temperature was adjusted to 65° C.

10 grs of the syrup was added to 90 grs of the mixture of fats and oats, and the temperature was adjusted to 55-60° C. The mixture became yellowish and more viscous. Stirring was continued for an additional 15-20 minutes.

Plastic containers were filled with the warm and homogeneous mixture. The composition of the resultant product is set forth below in Table 1.

TABLE 1

| COMPONENT | % W/W |
|---|---|
| HYDROGENATED AND REFINED ANIMAL FAT | 10.5 |
| LECITHIN | 5 |
| CURRY POWDER | 1 |
| POTASSIUM SORBATE | 0.2 |
| CORN FLOUR | 20.3 |
| SPINOSAD PRODUCT (44% purity) | 4.7 |
| DEIONISED WATER | 2 |
| FRUCTOSE | 16.8 |
| SOY BEAN OIL | 9.5 |
| QUAKER OATS (POWDERED) | 13 |
| LIQUID UNREFINED PORK FAT | 17 |

Bait products of this formulation (2% spinosad) were sent to biological test centers to analyze their efficacy against cockroaches. All mortality rates set forth in the Examples herein were measured in a mixed population consisting of 10 males, 10 females, and 10 nymphs (larvae). The results from multiple tests are set forth in Table 2 below.

TABLE 2
Example 1 Cockroach Mortality

| | | COCKROACH | | | | |
|---|---|---|---|---|---|---|
| | | AMERICAN | AMERICAN | GERMAN | GERMAN | GERMAN |
| | | 14 DAYS | 21 DAYS | 7 DAYS | 14 DAYS | 16 DAYS |
| TEST 1 | FEMALES | 57% | | 73% | 90% | 97% |
| | MALES | 60% | | 100% | 100% | 100% |
| | NYMPHS | 73% | | 87% | 97% | 97% |
| | AVERAGE | 63% | | 87% | 96% | 98% |
| TEST 2 | FEMALES | 40% | 80% | 30% | 77% | 93% |
| | MALES | 77% | 80% | 97% | 100% | 100% |
| | NYMPHS | 47% | 63% | 53% | 90% | 93% |
| | AVERAGE | 55% | 74% | 60% | 93% | 96% |

### Example 2

### Comparative

Bait products containing 2% Spinosad were prepared using a conventional bait matrix, which does not contain a specific masking agent. The components are set forth in Table 3 below.

TABLE 3
COMPONENT

HYDROGENATED AND REFINED ANIMAL FAT
LECITHIN 5%
CURRY POWDER
POTASSIUM SORBATE
CORN FLOUR
SPINOSAD PRODUCT (purity 44% )
DEIONISED WATER
FRUCTOSE
GLUCOSE
POWDER SUGAR
QUAKER OATS (POWDERED)

The bait products were sent to a biological test center to analyze their efficacy against cockroaches. The tests were preformed multiple times, and the data set forth herein are averages from the series of tests. The results are set forth in Table 4 below.

TABLE 4
Example 2 (Comparative) Cockroach Mortality

Cockroach

| | | American | German |
|---|---|---|---|
| | | 14 days | 14 days |
| Test 1 | Females | 12% | 0% |
| | Males | 32% | 5% |
| | Nymphs | 73% | 40% |
| | Average | 39% | 15% |
| Test 2 | Females | | 0% |
| | Males | | 23% |
| | Nymphs | | 3% |
| | Average | | 9% |

### Examples 3 and 4

Bait products of the present invention containing 5% Spinosad were prepared using the bait matrix of Example 1. In this Example, 11.7% of the commercially available Spinosad product (purity 44%) was used. The results are identified as Example 3 in Table 5 below.

Bait products of the present invention containing 0.5% Spinosad were also prepared using the bait matrix of example 1. In this Example, 1.18% of the commercially available Spinosad product (purity 44%) was used. The results are identified as Example 4 in Table 5 below.

TABLE 5
Examples 3 and 4 Cockroach Mortality

| | | | COCKROACH | | | |
|---|---|---|---|---|---|---|
| | | | AMERICAN | AMERICAN | GERMAN | GERMAN |
| | | | 14 DAYS | 21 DAYS | 14 DAYS | 21 DAYS |
| EXAMPLE 3 | TEST 1 | FEMALES | 70% | | | |
| | | MALES | 100% | | | |
| | | NYMPHS | 80% | | | |
| | | AVERAGE | 83% | | | |
| | TEST 2 | FEMALES | 77% | 83% | | |
| | | MALES | 87% | 93% | | |
| | | NYMPHS | 77% | 93% | | |
| | | AVERAGE | 80% | 90% | | |
| EXAMPLE 4 | TEST 1 | FEMALES | | | 90% | |
| | | MALES | | | 100% | |
| | | NYMPHS | | | 97% | |
| | | AVERAGE | | | 96% | |
| | TEST 2 | FEMALES | | | 87% | 97% |
| | | MALES | | | 100% | 100% |
| | | NYMPHS | | | 80% | 93% |
| | | AVERAGE | | | 89% | 97% |

### Example 5

Bait product A was prepared containing 2% Spinosad, comprised of microencapsulated and free spinosyn, using a conventional food matrix like that of Example 2, which contains no specific masking agents.

Comparative bait product B was prepared containing 2% Spinosad, comprised of free spinosyn, also using a conventional food matrix like that of Example 2, which contains no specific masking agents.

Both bait products were sent to a biological test center to determine their attractiveness to cockroaches using an infrared operating image analysis system according to method BioG B 505-01 (15 males, 15 females and 20 nymphs L4). It was observed that during 20 minutes of exposure to bait product A and B, 59% of cockroaches stayed at product A and 41% stayed at product B. Thus, it was demonstrated that the use of microencapsulated spinosyn provided almost 20% greater attractiveness as compared to the use of only free spinosyn.

### Example 6

Bait products containing 0.5% Spinosad were prepared starting from a conventional bait matrix which has been highly enriched for masking purpose in (A) lecithin and (B) soy bean oil. The components are set forth in Table 6 below. In this Example, 1.18% of the commercially available Spinosad product (purity 44%) was used. The results are identified as Table 7 below.

TABLE 6

| COMPONENT | % W/W (A) | % W/W (B) |
|---|---|---|
| HYDROGENATED AND REFINED | 24.3 | 22.3 |
| ANIMAL FAT | | |
| LECITHIN | 40.5 | 5 |
| CURRY POWDER | 1 | 1 |
| POTASSIUM SORBATE | 0.2 | 0.2 |
| CORN FLOUR | 8.1 | 14 |
| SPINOSAD PRODUCT (44% purity) | 1.18 | 1.18 |
| DEIONISED WATER | 2 | 2 |
| FRUCTOSE | 4.63 | 4.65 |
| GLUCOSE | 3.67 | 3.67 |
| POWDER SUGAR | 7.22 | 10 |
| QUAKER OATS (POWDERED) | 7.2 | 9 |
| SOY BEAN OIL | — | 27 |

TABLE 7
Example 6 Cockroach Mortality

COCKROACH

| | | GERMAN | GERMAN |
|---|---|---|---|
| | | 14 DAYS | 21 DAYS |
| TEST 1 (A) | FEMALES | 80% | 90% |
| | MALES | 100% | 100% |
| | NYMPHS | 73.3% | 83.3% |
| | AVERAGE | 84.4% | 91.1% |
| TEST 2 (B) | FEMALES | 46.7% | 66.7% |
| | MALES | 93.3% | 96.7% |
| | NYMPHS | 33.3% | 70% |
| | AVERAGE | 57.8% | 77.8% |

### Example 7

Bait products containing 1.1% and 2.2% cyphenothrin technical grade were prepared using unrefined animal fat as a masking agent. The formulations are set forth in Table 8 below. The results are identified as Table 9 below.

TABLE 8

| COMPONENT | % W/W | % W/W |
|---|---|---|
| HYDROGENATED AND REFINED ANIMAL FAT | 11 | 12 |
| LIQUID UNREFINED PORK FAT | 20.15 | 18.15 |
| CURRY POWDER | 1 | 1 |
| POTASSIUM SORBATE | 0.2 | 0.2 |
| CORN FLOUR | 20.67 | 19.5 |
| CYPHENOTHRIN TECHNICAL | 1.1 | 2.2 |
| DEIONISED WATER | 2 | 2 |
| FRUCTOSE | 15.73 | 16.8 |
| LECITHIN | 5 | 5 |
| QUAKER OATS (POWDERED) | 13.15 | 13.15 |
| SOY BEAN OIL | 10 | 10 |

TABLE 9
Example 7 Cockroach Mortality

| | | COCKROACH | |
|---|---|---|---|
| | | GERMAN | GERMAN |
| | | 14 DAYS | 21 DAYS |
| TEST 1 | FEMALES | 66.7% | 70% |
| (1.1% CYPHENOTHRIN) | | | |
| | MALES | 90% | 100% |
| | NYMPHS | 30% | 36.7% |
| | AVERAGE | 62.2% | 68.9% |

| | | COCKROACH | |
|---|---|---|---|
| | | AMERICAN | AMERICAN |
| | | 3 DAYS | 14 DAYS |
| TEST 2 | FEMALES | 56.7% | 100% |
| (2.2% CYPHENOTHRIN) | | | |
| | MALES | 100% | 100% |
| | NYMPHS | 46.7% | 63.3% |
| | AVERAGE | 67.8% | 87.8% |

What is claimed is:

1. A pest control product in an ingestible form, comprising:
at least one spinosyn or derivative or salt thereof; and
at least one masking agent;
wherein said product achieves at least 60% mortality in 21 days or less against cockroaches.

2. The product claim 1, wherein said at least one spinosyn is chosen from spinosyn A and spinosyn D.

3. The product of claim 1, wherein said at least one spinosyn is Spinosad.

4. The product of claim 1, wherein said spinosyn comprises a mixture of (2R,3αR,5αR,5βS,9S,13S,14R,16αS,16βR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,4,5,5α5β, 6,9,10,11,12,13,14,16α,6β-hexadecahydro-14-methyl-1H-as-indaceno[3,2-d]oxacyclodo decine-7,15-dione, and (2R,3αR,5αS,5βS,9S, 13S,14R,16αS,16βS)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,5α,5β,6,9,10,11,12,13,14,16α,16β-tetradecahydro-4,14-dimethyl-1H-as-indaceno[3,2-d]oxacyclododecine-7,15-dione. in the proportion 50-90% to 50-10%.

5. The product of claim 1, wherein said at least one spinosyn is a butenyl spinosyn.

6. The product of claim 1, wherein said product comprises from 0.005 to 20 weight percent of said at least one spinosyn.

7. The product of claim 5, wherein said product comprises from 0.5 to 5 weight percent of said at least one spinosyn.

8. A product of claim 1, wherein said masking agent comprises unrefined animal fat.

9. A product of claim 1, wherein said masking agent comprises at least two of animal fat, lecithin and vegetable oil.

10. A product of claim 9, wherein the lecithin and vegetable oil, if present, are present in an amount of 11% or greater.

11. A product of claim 1, wherein said masking agent is at least one of an odor neutralizer, a bitter taste inhibitor, and a para-hydroxyphenylacetic acid

12. The product of claim 1, further comprising at least one attractant, wherein said at least one attractant differs from said at least one masking agent.

13. The product of claim 1, further comprising at least one preservative or at least one anti-oxidant.

14. The product of claim 1, further comprising at least one synergist selected from piperonyl butoxide (PBO), n-octyl bicycloheptene dicarboximide (MGK), and Verbutin.

15. The product of claim 1, wherein said product achieves at least 70% mortality in 21 days or less.

16. The product of claim 1, wherein said product achieves at least 80% mortality in 21 days or less.

17. The product of claim 1, wherein said product achieves at least 90% mortality in 21 days or less.

18. The product of claim 1, further comprising at least one secondary active ingredient chosen from pyrethroids, nicotinoids, fiproles, organophosphates, carbamates, insect growth regulators, botanicals, inorganics, avermectins and hydramethylnon.

19. The product of claim 1, wherein said product achieves at least 60% mortality in 14 days or less against American cockroaches.

20. The product of claim 1, wherein said product achieves at least 80% mortality in 14 days or less against German cockroaches.

21. The product of claim 1, wherein said product is in the form of a bait station, a tube, a syringe, granules, dust, an aerosol, or a spray.

22. The product of claim 1, wherein said at least one spinosyn is Spinosad, said at least one masking agent is unrefined animal fat, and further comprising at least one preservative and at least one attractant, wherein said at least one attractant differs from said at least one masking agent.

23. A pest control product in an ingestible form, comprising:
at least one microencapsulated spinosyn or derivative or salt thereof, and
wherein said pest control product achieves at least 60% mortality in 21 days or less against cockroaches.

24. The product of claim 23, wherein said at least one spinosyn is Spinosad.

25. The product of claim 23, wherein said spinosyn comprises a mixture of (2R,3αR,5αR,5βS,9S,13S,14R,16αS,16βR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,4,5,5α5β,6,9,10,11,12,13,14,16α,6β-hexadecahydro-14-methyl-1H-as-indaceno[3,2-d]oxacyclodo decine-7,15-dione, and (2R,3αR,5αS,5βS,9S, 13S,14R,16αS,16βS)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,5α,5β,6,9,10,11,12,13,14,16α,16β-tetradecahydro-4,14-dimethyl-1H-as-indaceno[3,2-d]oxacyclododecine-7,15-dione. in the proportion 50-90% to 50-10%.

26. The product of claim 23, wherein said spinosyn is a butenyl spinosyn.

27. The product of claim 23, further comprising at least one secondary active ingredient chosen from pyrethroids, nicotinoids, fiproles, organophosphates, carbamates, insect growth regulators, botanicals, inorganics, avermectins and hydramethylnon.

28. The product of claim 23, wherein said product further comprises at least one attractant and/or at least one food ingredient.

29. The product of claim 23, wherein said product further comprises at least one preservative or at least one anti-oxidant.

30. The product of claim 23, wherein said product achieves at least 70% mortality.

31. The product of claim 23, wherein said product achieves at least 80% mortality.

32. The product of claim 23, wherein said product achieves at least 90% mortality.

33. A method for reducing cockroach populations comprising:
administration of an ingestible product comprising:
at least one spinosyn or derivative or salt thereof; and
at least one masking agent; and
wherein said method achieves at least 60% mortality in 21 days or less against cockroaches.

34. The method of claim 33, wherein said at least one spinosyn is Spinosad.

35. The method of claim 33, wherein said spinosyn comprises a mixture of (2R,3αR,5αR,5βS,9S,13S,14R,16αS,16βR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,4,5,5α5β,6,9,10,11,12,13,14,16α,6β-hexadecahydro-14-methyl-1H-as-indaceno[3,2-d]oxacyclodo decine-7,15-dione, and (2R,3αR,5αS,5βS,9S, 13S,14R,16αS,16βS)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,5α,5β,6,9,10,11,12,13,14,16α,16β-tetradecahydro-4,14-dimethyl-1H-as-indaceno[3,2-d]oxacyclododecine-7,15-dione. in the proportion 50-90% to 50-10%.

36. The product of claim 33, wherein said spinosyn is a butenyl spinosyn.

37. The method of claim 33, wherein said product comprises at least one spinosyn from 0.005 to 20 weight percent.

38. The method of claim 33, wherein said at least one masking agent is chosen from unrefined animal fat, an odor neutralizer, a bitter taste inhibitor, a para-hydroxyphenylacetic acid. and a combination of at least two of animal fat, lecithin, and vegetable oil.

39. The method of claim 33, wherein said at least one spinosyn is Spinosad, said at least one masking agent is unrefined animal fat, and wherein said product further comprises at least one preservative and at least one attractant, wherein said at least one attractant differs from said at least one masking agent.

40. A method for reducing cockroach populations comprising:
administration of a product comprising:
at least one microencapsulated spinosyn or derivative thereof,
wherein said pest control product achieves at least 60% mortality in 21 days or less against cockroaches.

41. The method of claim 40, wherein said at least one spinosyn is Spinosad.

42. The method of claim 40, wherein said spinosyn comprises a mixture of (2R,3αR,5αR,5βS,9S,13S,14R,16αS,16βR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,4,5,5α5β,6,9,10,11,12,13,14,16α,6β-hexadecahydro-14-methyl-1H-as-indaceno[3,2-d]oxacyclodo decine-7,15-dione, and (2R,3αR,5αS,5βS,9S, 13S,14R,16αS,16βS)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3α,5α,5β,6,9,10,11,12,13,14,16α,16β-tetradecahydro-4,14-dimethyl-1H-as-indaceno[3,2-d]oxacyclododecine-7,15-dione. in the proportion 50-90% to 50-10%.

43. The method of claim 40 wherein said spinosyn is a butenyl spinosyn.

44. The method of claim 40, wherein said product comprises at least one spinosyn from 0.005 to 20 weight percent.

45. The product of claim 9, wherein the vegetable oil comprises soy bean oil.

46. The method of claim 38, wherein the vegetable oil comprises soy bean oil.

47. A method of formulating a spinosyn containing bait effective against a population of pests which are repelled by spinosyn comprising:
identifying an effective amount of spinosyn,
formulating a spinosyn containing bait containing said effective amount of spinosyn such that said bait is not repellant to said pest.

48. The method of claim 47, wherein said formulating includes the addition of a masking agent.

49. A pest control product in an ingestible form, comprising:
at least one pyrethrin; and
at least one masking agent chosen from:
5-50% unrefined animal fat and/or 5-50% lecithin and/or 5-50% soybean oil
wherein said product achieves at least 60% mortality in 21 days or less against cockroaches.

50. The product of claim 49, further comprising one or more of the following:
0.1-5% of an attractant;
0.01-1% of a preservatives or antioxidants;
3-30% carbohydrates;
5-40% starches or oats; and
3-40% hydrogenated fat.

51. The product of claim 49, wherein the pyrethrin is chosen from sumithrin and cyphenothrin.
